(19) United States
(12) Patent Application Publication
(10) Pub. No.: US 2014/0213645 A1
(43) Pub. Date: Jul. 31, 2014

(54) THERMAL STABILIZATION OF IPBC BIOCIDE

(71) Applicant: Joseph A. Bartko, Nazareth, PA (US)

(72) Inventor: Joseph A. Bartko, Nazareth, PA (US)

(21) Appl. No.: 14/228,918

(22) Filed: Mar. 28, 2014

Related U.S. Application Data
(63) Continuation of application No. 10/893,009, filed on Jul. 16, 2004, now abandoned.

(51) Int. Cl. A01N 47/12

(52) U.S. Cl. CPC A01N 47/12
USPC 514/478

(57) ABSTRACT

A biocide, e.g. IPBC (3-iodo-2-propynl butylcarbamate), is stabilized against thermal degradation in matrix compositions which are processed at elevated temperatures, by blending the IPBC with a stabilizer additive, e.g. calcium stearate and/or a hindered phenol, alone or in combination therewith.

### BACKGROUND OF THE INVENTION

1. Field of the Invention

This invention relates to compositions requiring a biocide for protection against microorganisms, and, more particularly, to stabilization of a biocide in matrix compositions requiring processing at high temperatures.

2. Description of the Prior Art

IPBC (3-iodo-2-propynl butyl carbamate) is a well known preservative in cosmetic, paint and coating products where it is added to the formulation at room temperature. However, since IPBC melts at about 67° C. and degrades rapidly thereafter, it is considered unsuitable for use in compositions which are processed at high temperatures, e.g. during extrusion of polymers and plastics, e.g. polyolefins or PVC, or polymer-wood composites, where processing temperatures of up to 250° C. may be required.

Specifically, because of its low melting and degradation point IPBC quickly melts and sticks to the walls of metal extruders normally used at high temperatures in production of plastics, extruders and molders whereupon the IPBC degrades rapidly.

Accordingly, it is an object of this invention to provide a matrix composition containing a biocide, e.g. IPBC or 3-iodopropynyl carbamate (IPC) or 3-iodopropynyl-N-phenyl carbamate (IPPC) which does not degrade at the elevated temperatures used during processing of the compositions, particularly during extrusion of polymers, plastics and polymer-wood composites, at temperatures up to 250° C., e.g. in both single and twin screw extruders.

Another object herein is to provide an external lubricant which would provide a microscopic barrier between a polymer matrix and hot metal extruder surfaces to stabilize IPBC at elevated temperatures.

### SUMMARY OF THE INVENTION

What is described herein is a concentrate a biocide, e.g. IPBC, and an additive therein for stabilization of the IPBC in a matrix such as a plastic, e.g. polyolefin, against thermal degradation during processing of the matrix at temperatures up to 250° C.

A preferred thermal stabilizer additive for IPBC in this invention is calcium stearate, wherein IPBC can be present in an amount, by wt., of up to 15%, and the stabilizer additive in an amount up to 3%, preferably up to 10% IPBC and up to 1% stabilizer additive.

The invention also includes a concentrate of 7-15 wt. % IPBC and 1-5 wt. % stabilizer additive, and/or addition of a hindered phenol (antioxidants). The addition of hindered phenols will further enhance thermal processing stability.

In this invention, compositions of a polyolefin, IPBC and a stabilizer additive are provided to protect the IPBC against thermal degradation during processing of the polyolefin into a finished product, e.g. by extrusion at elevated temperatures up to 250° C.

Suitable polyolefin compositions includes, by wt., 30-95% polyolefin, e.g. polyethylene or polypropylene, 5-15% IPBC and 1-3% stabilizer additive, e.g. calcium stearate. Preferable compositions include 40% polyolefin, e.g. linear low density polyethylene (LLDPE), 10% IPBC and 1% calcium stearate.

Other suitable matrix materials in which IPBC may be stabilized against thermal degradation herein includes wood-plastic composites, carpet backing, PVC pipes, roofing membranes, shower curtains, and the like.

Optional ingredients may be included in the matrix without affecting the stability of the biocide, e.g. colorants, light and UV stabilizers, anti-static agent, coupling agents, etc.

### DETAILED DESCRIPTION OF THE INVENTION

The plastics industry requires processing materials under high temperatures, e.g. flexible PVC at about 175° C., olefins such as polypropylene and polyethylene at about 200° to 230° C., and polymer-wood composites, at about 220° C. Therefore biocides for use therein must be able to withstand those elevated temperatures for anywhere from 3-10 minutes without degrading.

Typical olefin polymers include HDPE (high density polyethylene) LDPE (low density polyethylene), LLDPE (linear low density polyethylene), PP (polypropylene), HDPP (high density polypropylene), LDPP (low density polypropylene), WHMWPE (ultra high molecular wt. polyethylene) and MPE (metallocene/polyethylene).

Suitable polyolefinic compositions include, by weight, 30-95% polyolefin, e.g. polyethylene or polypropylene, 5-15% IPBC and 1-3% stabilizer additive. Suitable stabilizer additives include the following:
Acid-Ester Lubricants,
Low-Molecular-Weight Polyethylene,
White Oils,
Ethylene Bis Stearamide,
Fatty Acids,
Fatty Acid Amines,
Fatty Acid esters,
Metals Soaps of Fatty Acids,
Fluoropolymers,
Calcium Stearate,
Zinc Stearate,
   mixtures thereof and waxes, complex polymeric blends, processing aids, amides and simple esters.

A preferred composition is 89% polyolefin, e.g. linear low density polyethylene (LLDPE), 10% IPBC and 1% calcium stearate.

Optional ingredients may be included in the matrix without affecting the stability of the biocide, e.g., colorants, light and UV stabilizers, anti-static agent, coupling agents, fillers, extenders and reinforcing agents such as calcium carbonate, talc, mica, silica, kaolin, impact modifiers, glass fibers, carbon fibers blowing agents, flame retardants, wood and wood flour, and the like.

Other suitable matrix materials which may be stabilized herein include wood-plastic composites, shower curtains, cable and wire insulation, filter medias, polymer components of carpet, seat cushions, hose, pipe, flooring, decking, window frames, fencing, automobile interiors, pallets and outdoor furniture.

The invention will now be described by reference to the following examples.

### EXAMPLE 1

### CONTROL

A mixture of 90% by weight low melting linear low density polyethylene, (LLDPE), m.p. 125° C., and 10% IPBC showed very early signs of degradation in a heated mixing bowl at 125° C. Degradation was evidenced by a severe discoloration of the mixture.

### EXAMPLE 2

### INVENTION

A mixture of 10-90% LLDPE, 7.5% IPBC and 1% calcium stearate was extruded in a commercial single screw extruder at 130° C. into pellets. The pellets retained their original pure, white appearance with no sign of degradation. In contrast, LLDPE pellets and IPBC, made at the same temperature without calcium stearate present, rapidly discolorized, showing that the IPBC degraded.

Example 2 was repeated with a composition 89% LLDPE, 10% IPBC and 1% calcium stearate. Similar results were obtained.

### EXAMPLE 3

Sample pellets were made in a polypropylene matrix at 220° C. with mixtures of stabilized IPBC. Using the pellets produced with and without calcium stearate and mixing to result in a final IPBC concentration of 1%, those samples with calcium stearate showed little degradation while those made without calcium showed rapid IPBC degradation.

### EXAMPLE 4

Examples 2 and 3 were repeated using a composition which includes, by weight, 38% polypropylene, 50% wood chips/flour, with 1% IPBC and 1% calcium stearate. No degradation was observed when processed at 220° C.

While the invention has been described with particular reference to certain embodiments thereof, it will be understood that changes and modifications may be made which are within the skill of the art. Accordingly, it is intended to be bound only by the following claims, in which:

What is claimed is:

1. A method of processing an IPBC-containing composition at high temperatures without degrading the IPBC which comprises including a stabilizer additive in the compositions.

2. A method according to claim 1 wherein said composition includes a matrix which is a polyolefin, flexible polyvinylchloride, a polyurethane or a wood composite.

3. A method according to claim 2 wherein said stabilizer additive is calcium stearate.

4. A method according to claim 2 wherein the stabilizer additive also includes an antioxidant.

5. A method according to claim 4 wherein said antioxidant is a hindered phenol.
